(19) United States
(12) Patent Application Publication
(10) Pub. No.: US 2015/0217310 A1
(43) Pub. Date: Aug. 6, 2015

(54) METERING DEVICE AND METHOD FOR METERING ADDITIVES INTO TREATMENT LIQUIDS OF A VEHICLE TREATMENT INSTALLATION

(71) Applicant: WashTec Holding GmbH, Augsburg (DE)

(72) Inventors: Robert Auer, Stadtbergen (DE); Franz Kiser, Ried (DE); Georg Wimmer, Affing (DE)

(73) Assignee: Wash Tec Holding GmbH, Augsburg (DE)

(21) Appl. No.: 14/422,862

(22) PCT Filed: Aug. 19, 2013
(86) PCT No.: PCT/EP2013/067246

§ 371 Date: Feb. 20, 2015

(30) Foreign Application Priority Data
Aug. 20, 2012 (DE) 10 2012 107 618.9

(51) Int. Cl. B05B 7/24; B60S 3/04; B01F 5/04

(52) U.S. Cl. CPC B05B 7/24; B01F 5/0403; B60S 3/04

(57) ABSTRACT

A metering device for metering additives into treatment liquids of a vehicle treatment installation includes an exchangeable storage container and a metering pump connected to the storage container, said metering pump metering an additive contained in the storage container into the treatment liquid. The metering device according to the invention comprises an integrated storage tank which communicates with the metering pump and with the storage container, thereby removing the need for a complete evacuation of the storage container and allowing the timely and easy exchange of a completely evacuated storage container without having to shut the vehicle treatment installation down to replace an evacuated storage container for a filled storage container.

The invention concerns a metering device for metering additives into treatment liquids of a vehicle treatment installation according to the preamble of claim 1. The invention also concerns a method for metering additives into treatment liquids of a vehicle treatment installation by means of such a metering device.

For the operation of vehicle wash installations, such installations are provided with various chemical additives, such as wash shampoos, foaming agents, waxes, drying aids, soaps, wheel rim cleaners, insect removers, etc., in order to supply these chemical additives to the treatment liquid (as a rule, water) with which the vehicle is treated. The chemical additives are thereby, as a rule as an aqueous solution, poured into storage containers, from which the additives are suctioned off with a pump via hoses that have been introduced therein. Frequently, the storage containers are present in the form of canisters. The handling of such canisters is very cumbersome—energy-sapping and also hazardous to the health of the operating personnel—because when replacing an evacuated canister with a filled canister, it is possible for the chemical additives, which are to some extent hazardous to health, to squirt out.

From EP 1 414 682-A, a device is known for providing a vehicle wash installation with chemical additives, with which a simple and energy-efficient and quick replenishing of the chemical additives is made possible; at the same time, the costs for storing the storage containers are lower. For this purpose, the additive is present in a highly concentrated form and is contained in a cartridge. The cartridge is placed on a holding device of the vehicle wash installation so that the additive contained in the cartridge can be continuously taken from the cartridge as needed. The highly concentrated additives can thereby be present in solid, pasty, liquid, pulverized or tablet form, and are encapsulated in the cartridge. If a cartridge is emptied, it can be replaced by a new, filled cartridge. In this way, it is possible to dispense with a tedious and time-consuming replenishing of the additive in the storage container.

Another vehicle wash installation in which highly concentrated additives are used and are metered into the treatment liquid of the wash installation by means of a conveyance pump is known from EP 896 914 A1.

From WO2008/125665 A2, a vehicle wash installation and a method for metering additives into treatment liquids of such a vehicle wash installation are known, wherein the vehicle wash installation has several cartridge holders to hold cartridges that contain (different) additives for the treatment liquids. The vehicle wash installation also comprises a (single) metering unit to meter additives from the cartridges into the treatment liquid and a control unit to control the metering unit. The cartridges are thereby provided with a data carrier, which contains data for the content of the cartridges, which can be read by means of a sending/receiving unit and which can be passed on to the control unit, so that the control unit can select a specific cartridge with the aid of the cartridge data so as to meter the additive contained in the cartridge in a suitable quantity into the treatment liquid. Preferably, the data carrier is a transponder. During the operation of the vehicle wash installation, the quantity of additive released from a cartridge inserted into the cartridge holder is calculated with the aid of the control commands specified by the control unit for the metering device so that the emptying of the cartridge can be recognized and indicated in time. In this way, a costly and disruptive measurement of the filling level of the additive in the cartridge can be avoided.

The known device and method for the metering of additives into treatment liquids of vehicle treatment installations prove to be disadvantageous in that the cartridges in which the additives are present, particularly in a highly concentrated form, cannot be evacuated completely without shutting down the vehicle treatment installation, so as to replace the essentially emptied cartridge with a new, filled cartridge. It is true that, for example, the operator of the vehicle wash installation known from WO2008/125456 A2, in a timely manner before the cartridge is empty, receives an appropriate indication so that a largely evacuated cartridge can be replaced early enough with a new, filled cartridge before it has been completely evacuated. To replace the cartridge, however, the vehicle wash installation must be shut down and the replacement of a largely evacuated cartridge must be carried out before its complete evacuation so as to prevent the content of the corresponding cartridge from not being available during the operation of the vehicle wash installation. Moreover, the known devices and methods for the metering of additives into the treatment liquids of vehicle treatment installations also prove to be disadvantageous in that, under certain circumstances, several cartridges have to be replaced within shorter time periods and at unfavorable times, for example, on the weekend, wherein in order to replace each individual cartridge, the operators have to travel a far distance in order to replace the largely evacuated cartridges with new cartridges.

On this basis, the goal of the invention is to further develop a generic metering device and a method for the metering of additives into treatment liquids of a vehicle treatment installation in such a way that a complete evacuation of the storage containers in which the additives are contained is allowed, along with a timely and uncomplicated replacement of a completely evacuated storage container, without the vehicle treatment installation having to be shut down for the replacement of an evacuated storage container with a filled storage container. The metering device and the method for the metering of additives into treatment liquids of vehicle treatment installations should also make it possible to simultaneously replace several (largely or completely) evacuated storage containers with new, filled storage containers, so as to, in this way, guarantee the most efficient replacement of the evacuated storage containers possible, without having to shut down the vehicle treatment installation for the replacement of the storage containers.

These goals are attained with a metering device with the features of claim 1 and with a method with the features of claim 13.

For these purposes, the metering device in accordance with the invention comprises a replaceable storage container and a metering pump connected with the storage container that meters an additive contained in the storage container into the treatment liquid of the vehicle treatment installation. In order to guarantee a sufficiently long remaining life of the metering device and thus of the vehicle treatment installation if the storage container has been largely evacuated, a storage tank, integrated in the metering device, is provided in the metering device in accordance with the invention; on the one hand, it is connected with the metering pump and, on the other hand, with the storage container. In contrast to the replaceable storage container, the integrated storage tank cannot be removed or replaced, but rather is firmly integrated in the metering device. The metering pump is thereby appropriately connected with the replaceable storage container only via the integrated storage tank.

The replaceable storage container appropriately has an outlet opening that is connected with an inlet opening in the storage tank so as to transfer the additive contained in the storage container to the storage tank and to fill it with the additive. Preferably, the inlet opening is located in the upper area of the storage tank so as to guarantee that the additive coming from the replaceable storage container can be transferred into the integrated storage tank in such a way that it can be essentially completely filled with the additive.

Preferably, there is a filling level meter or a flow meter in the storage tank and/or in the storage container. If a filling level meter is used, it is preferably located in the upper area of the storage tank where the inlet opening is also located. If a flow meter is used, it is appropriately located in the inlet opening of the storage tank so as to record the flow quantity of the additive that is transferred from the replaceable storage container to the integrated storage tank.

Preferably, a venting opening is provided in the integrated storage tank. It is appropriately located on the upper end of an ascending tube. The venting opening guarantees a venting of the storage tank when an evacuated storage container (cartridge) is removed from the metering device and is not replaced by a new storage container. In this case, the inlet opening in the storage tank is closed. The additive is removed from the integrated storage tank by means of the metering pump, and new additive does not subsequently flow from the storage container (cartridge). A reduced pressure would be established in the storage tank without an additional venting; the metering pump can no longer overcome it if the inlet opening in the storage tank is closed in the case of a removed storage container. As soon as additive is removed from the storage tank (without a storage container (cartridge) inserted into in the metering device), the level in the ascending tube located on the storage tank drops and finally, the storage tank is vented via the venting opening in the ascending tube. Upon insertion of a new storage container (cartridge), the integrated storage tank and the ascending tube are again filled with additive.

The metering pump is controlled by a control unit, wherein the control unit comprises a data processing device. The values recorded by the filling level meter or by the flow meter are supplied to the control unit in a preferred embodiment of the invention, in order to be able to process the recorded filling level or the recorded flow quantity in the data processing device of the control unit to control the metering pump. The control unit thereby appropriately controls the metering pump as a function of parameters that are supplied to the data processing device or that are stored in a data storage unit of the data processing device. The parameters that are taken into consideration by the control unit to control the metering pump can, for example, comprise ambient parameters, such as the ambient temperature, the air pressure, the air humidity, and precipitation values. The parameters can also comprise material parameters of the additive and/or the treatment liquid, such as the viscosity or the density of the additive or the degree of hardness and/or the pH value of the treatment liquid.

In a preferred embodiment example, the control unit can be controlled from a remote site via a remote control by means of a data conduit or a wireless data connection, for example, a radio or mobile radio connection.

Preferably, the replaceable storage container is provided with a data carrier that contains data for the additive contained in the storage container. The data for the additive can be, for example, the precise designation, the chemical composition, the concentration, the density, and the viscosity, the recommended processing temperatures, the expiration date, or a recommended dilution ratio with a solvent, etc. The data stored in the data carrier for the additive contained in the storage container can then be read with a sending/receiving unit and transmitted to the data processing device of the control unit. Conversely, it is also possible to store data in the data carrier of the replaceable storage container by means of the sending/receiving unit. Thus, it is, for example, possible to store the filling level of a partially evacuated, replaceable storage container on the data carrier, if the storage container is to be removed and stored for later use.

The metering device in accordance with the invention is used as intended for the metering of additives into treatment liquids of a vehicle treatment installation in that, first, a filled storage container is made available, which appropriately contains the additive in a highly concentrated form. The filled storage container is first inserted into a holder of the metering device provided for the purpose. Subsequently, a connection is produced between the replaceable storage container and the integrated storage tank so as to transfer the additive contained in the replaceable storage container to the storage tank, until it is completely filled. Afterward, the additive contained in the storage tank can be suctioned out of the storage tank by means of the metering pump and metered into the treatment liquid in a prespecified metering quantity and with an adjusted metering capacity.

Preferably, during the operation of the metering device, the filling level of the additive in the storage tank or the flow of the additive from the storage container to the storage tank is recorded. As soon as the recorded filling level or the recorded flow quantity falls short of a prespecified limiting value, the control unit emits a signal, wherein the signal can be an optical or an acoustic signal. The signal can also be transmitted via a data conduit or a wireless data connection to the location of an operator in order to transmit the recorded filling level or the recorded flow quantity to the operator. Appropriately, the data processing device of the control unit calculates a remaining, still expected life for the metering device from the recorded filling level or from the recorded flow quantity. The remaining life is thereby essentially determined by the volume of the integrated storage tank and the selected metering capacity of the metering device.

The desired metering capacity of the metering device during the remaining life is appropriately calculated by taking into consideration ambient parameters or material parameters and is adjusted to a suitable theoretical value. In the calculation of a suitable theoretical value for the metering capacity, the previous real metering capacity of the metering device can appropriately be taken into consideration, which, for example, can be determined by recording the metering quantity per unit time via a stroke count of the metering pump.

A vehicle treatment installation can appropriately be equipped with a number of metering devices in accordance with the invention, wherein each metering device has a holder for a replaceable storage container, an integrated storage tank, and a metering pump, and the metering pumps of the individual metering devices are controlled by a central control unit. This makes it possible for the treatment liquid to be acted on with several different additives, simultaneously or sequentially, in that the additives contained in the replaceable storage containers are metered into the treatment liquid to the metering device correlated with them, simultaneously or one after the other. The metering (metering quantity, metering capacity) of the individual additives and the chronological order of metering are thereby controlled by the central control unit. Preferably, the vehicle treatment installation is a vehicle cleaning installation for the washing of vehicles with washing brushes and/or high-pressure cleaning installations, the application of wax and/or the polishing of vehicle surfaces. The vehicle treatment installation can be advantageously equipped as a portal system, a drive-through system, or a system with forced conveyances of the vehicles.

These and other advantages and features of the metering device in accordance with the invention and the method in accordance with the invention can be deduced from the embodiment example described in more detail below with reference to the accompanying drawings. The drawings show the following:

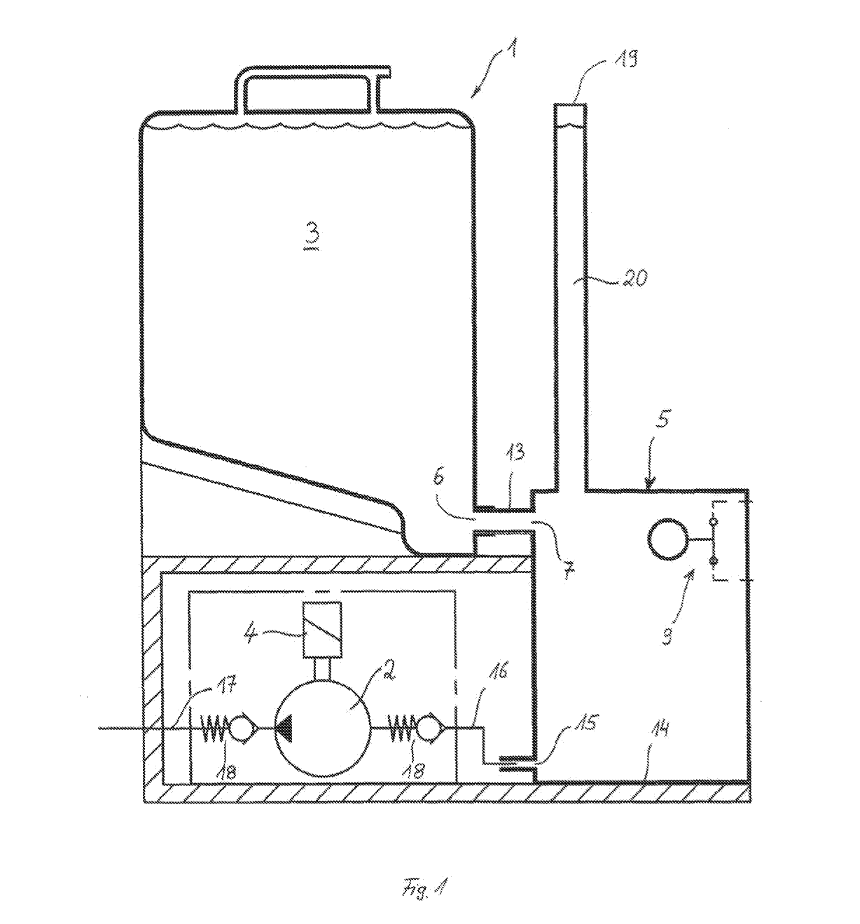

FIG. 1: a schematic representation of a metering device in accordance with the invention with a completely filled storage container and a completely filled storage tank;

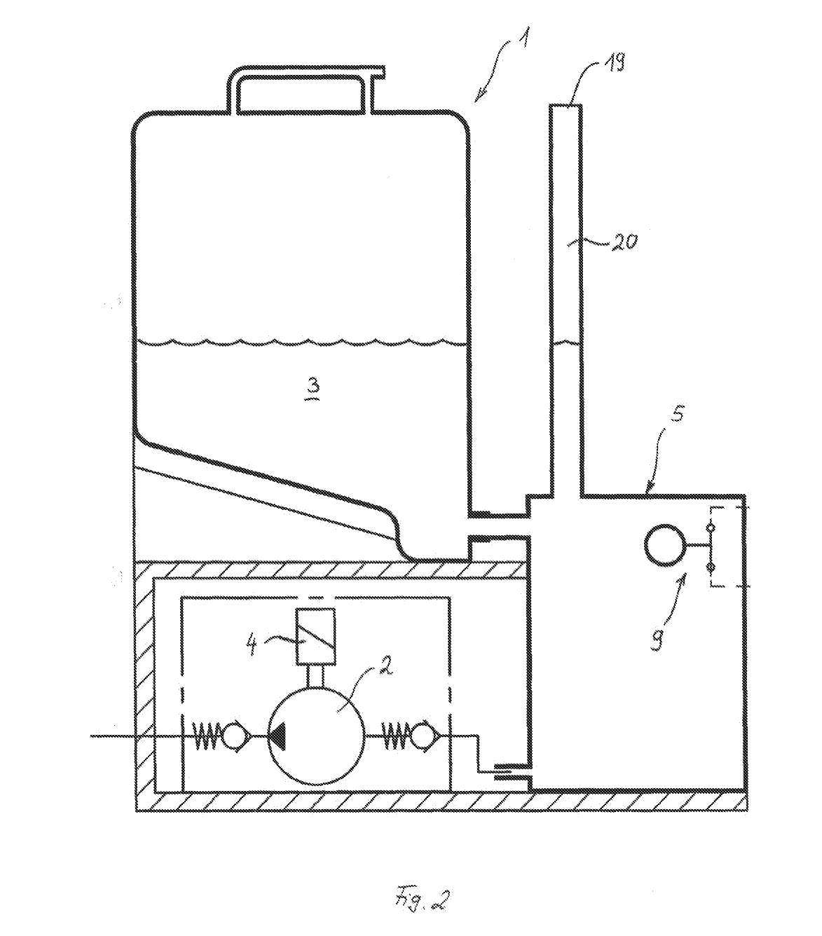

FIG. 2: a schematic representation of the metering device of FIG. 1 with a partially evacuated storage container and a completely filled storage tank;

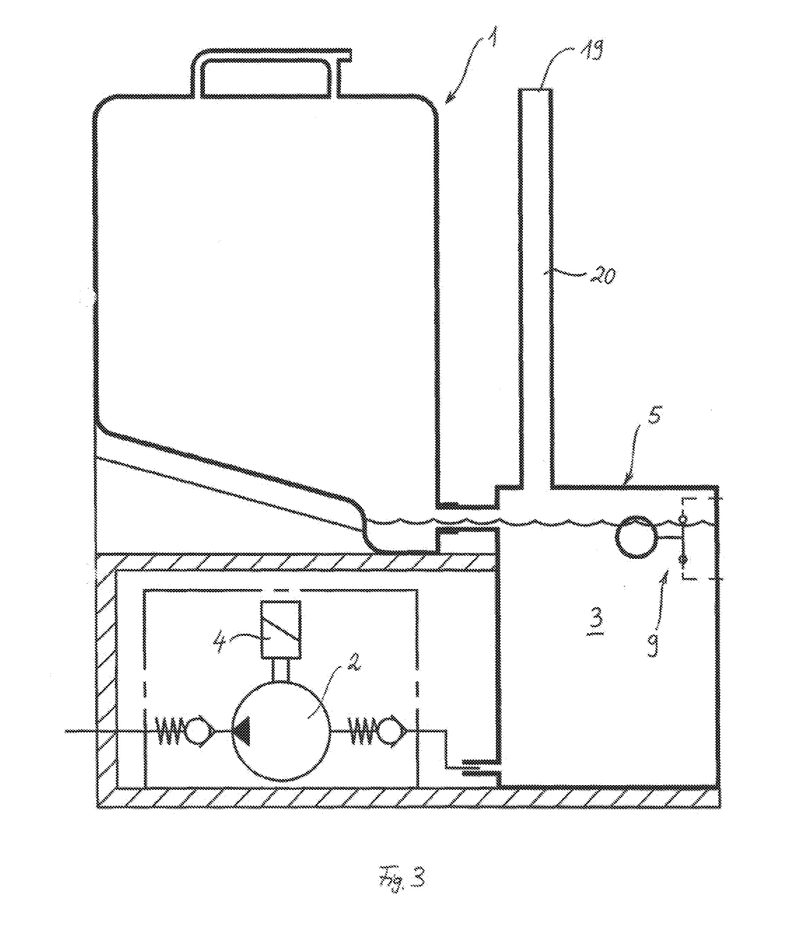

FIG. 3: a schematic representation of the metering device of FIG. 1 with an essentially evacuated storage container and a still largely completely filled storage tank;

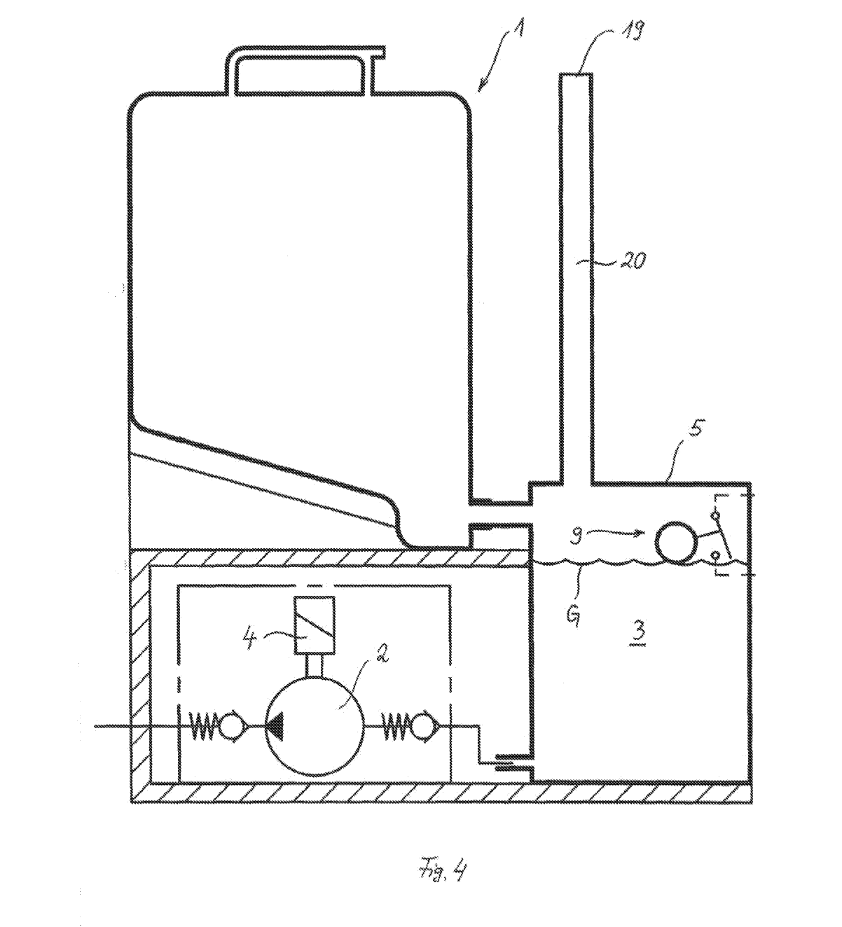

FIG. 4: a schematic representation of the metering device of FIG. 1 with a completely evacuated storage container and a partially filled storage tank;

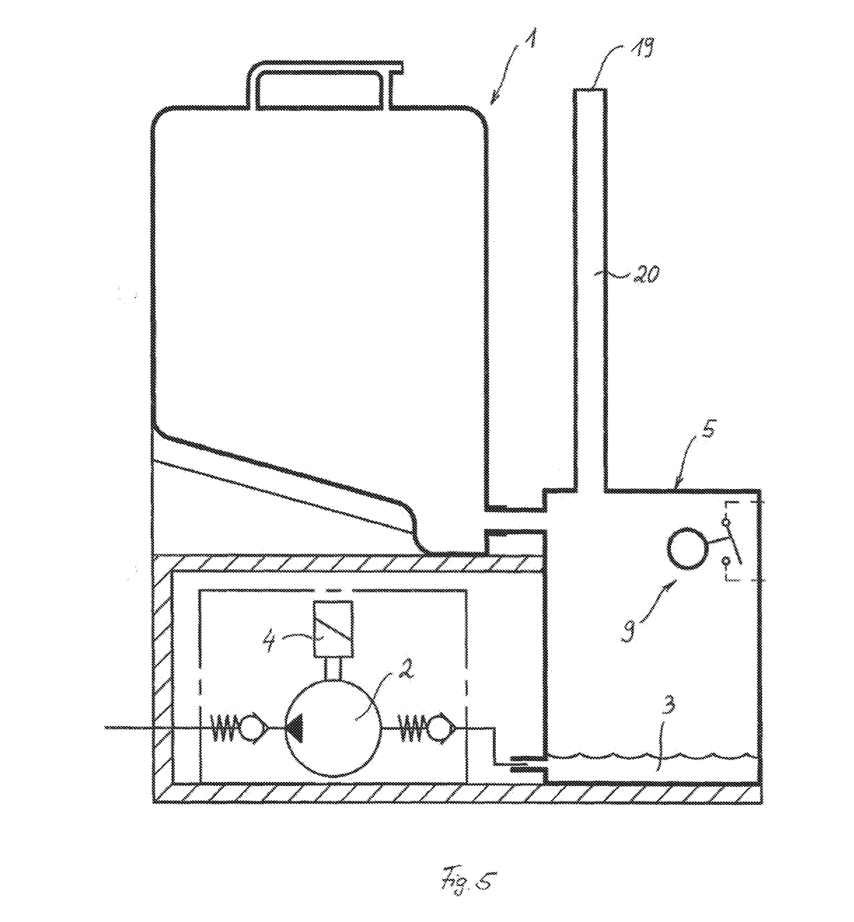

FIG. 5: a schematic representation of the metering device of FIG. 1 with a completely evacuated storage container and a largely evacuated storage tank;

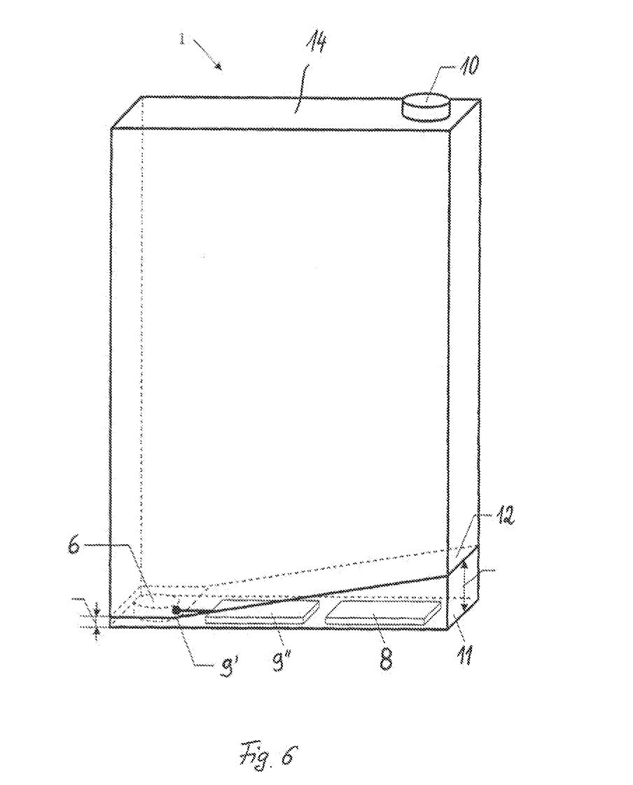

FIG. 6: a perspective representation of a replaceable storage container for use in a metering device in accordance with the invention.

The metering device for the metering of additives into treatment liquids of a vehicle treatment installation, schematically shown in FIG. 1, comprises a replaceable storage container 1 in which a chemical additive 3 is contained. The chemical additive 3 is, for example, a washing shampoo, a foaming agent, soap, wax, a wheel rim cleaner, an insect remover, a polishing agent, or other additives that are usually used for the surface treatment of a vehicle. Appropriately, the additive contained in the replaceable storage container 1 is present in a highly concentrated form, as a liquid or as a gel. The additives, however, can also be present in a solid form, for example, as a powder, granules, or in tablet form. The replaceable storage container 1 is inserted into a holder, which is not represented graphically here. Appropriately, the holder is designed in such a way that it holds the storage container 1 to be held in a form-locking manner, for example, and fixes it in the holder, for example, by means of a locking mechanism. The storage container 1 can then be removed from the holder in an appropriate manner by loosening the locking mechanism.

The storage container 1 is shown in detail in FIG. 6. Such a storage container 1 is known from DE 10 2006 022 477 A1. Reference is therefore made to the disclosure of this Offenlegungschrift document and to the subject of the disclosure of the application under consideration. The storage container 1, which is essentially designed rectangular, has a container bottom 11 and side walls connected as one piece with the bottom 11, and a cover 14, which is formed on it as one piece. Appropriately, the storage container 1 is made of a hard plastic, for example, polyethylene. A filling opening 10, which can be closed, is preferably provided in the cover 14, wherein the filling opening can be appropriately closed air- and liquid-tight with a suitable closure. An interior space bottom 12 is provided in the lower area of the storage container 1; it runs at an incline relative to the container bottom 11 in the embodiment example shown in FIG. 6. The interior space bottom 12 can also run parallel to the container bottom 11. A data carrier 8 is located between the interior space bottom 12 and the container bottom 11. The data carrier 8 is, in particular, a transponder. The transponder contains data for the content of the storage container 1, that is, in particular, for the additive contained therein. The data for the content of the storage container 1 can be, for example, the precise volume of the content, the designation and/or the chemical composition of the additive, the viscosity, the density, and perhaps other material parameters. An outlet opening 6 is provided in the container bottom 11. The outlet opening 6 can also be located in the lower area of the storage container 1, in a side wall. In a preferred embodiment example, a flow meter 9′, with an electronic measurement unit 9″ coupled with it, is located in the outlet opening 6 of the storage container 1. The flow meter 9′ is used for the recording of the flow quantity that flows from the storage container 1 through the outlet opening 6, if the storage container 1 is used as intended in a metering device in accordance with the invention.

The metering device in accordance with the invention comprises, moreover, an integrated storage tank 5, that is, one firmly incorporated in the metering device. This is likewise appropriately made of a hard plastic and designed, for example, in rectangular form, wherein other forms, such as a cylindrical form, are also possible. The integrated storage tank 5 has an inlet opening 7 in its upper area. The inlet opening 7 is directly connected with the outlet opening 6 of the replaceable storage container 1 via a connecting piece 13 (therefore, directly, that is, without an interposition of valves, pumps, or the like). The connecting piece 13 can be, for example, a connecting hose or a connecting tube. By means of the connecting piece 13, the additive 3 that is found in the storage container 1 can be transferred from the storage container 1 to the integrated storage tank 5, so that a pure (that is, undiluted and not mixed with other (additive) agents) additive 3 is found in the storage tank 5. Preferably, a filling level meter 9 is located in the upper area of the storage tank. Appropriately, the filling level meter 9, as shown in the graphically represented embodiment example, is located within the storage tank on the side wall opposite the inlet opening 7. In a supplementary or also alternative manner to the filling level meter 9 and, perhaps, supplementary to the flow meter 9′ located in the storage container 1, a flow meter can also be located in the inlet opening 7 of the storage tank 5.

With the filling level meters 9 or the flow meters 9′, it is possible to determine whether the additive 3 found in the replaceable storage container 1 is being transferred from the storage container 1 to the integrated storage tank 5 so as to fill it with the additive.

In the area of the tank bottom 14, there is an outlet opening 15 in a side wall of the storage tank 5. The outlet opening 15 can also be located in the tank bottom 14 of the storage tank 5. The outlet opening 15 of the storage tank 5 is connected with a metering pump 2 via a connecting conduit 16. The metering pump 2 is, in turn, connected with a reservoir for a treatment liquid of the vehicle treatment installation via another connecting conduit 17. A nonreturn valve 18 is located in the connecting conduits 16 and 17. The metering pump 2 is coupled with a control unit 4 to control the metering pump. The control unit 4 comprises a data processing device, which, in turn, is coupled with the filling level meter 9 and/or the flow meters 9′. The measurement values recorded by the filling level meter 9 or the flow meters 9′ are supplied to the data processing device of the control unit 4 for further processing and for the control of the metering pump. Moreover, other data for the additive contained in the replaceable storage container 1 are appropriately stored in the data processing device of the control unit 4. For the transmission of the data of the additive to the data processing device of the control unit 4, it is preferably coupled with a sending/receiving unit that can read the data for the additive from the data carrier 8 and pass it on to the data processing device of the control unit 4. It is also possible to pass on additional data for the additive contained in the storage unit 1 to the data processing device of the control unit 4, for example, via an external data input device (such as a data carrier or a wireless data connection). These data can be, for example, a viscosity curve that indicates the dependence of the viscosity of the additive on the temperature and/or the air pressure. These data can also be stored in the data carrier 8 that is located in the replaceable storage container 1.

A venting opening 19 is provided in the integrated storage tank 5. It is appropriately located on the upper (open) end of an ascending tube 20. The venting opening 19 guarantees a venting of the storage tank when an evacuated storage container 1 is taken from the metering device and is not replaced again with a new storage container. In this case, the inlet opening 7 in the storage tank 5 is closed. The additive is removed from the integrated storage tank via the metering pump, and there is no subsequent flow of new additive from the storage container (cartridge). A reduced pressure would be established in the storage tank without an additional venting; the metering pump 2 can no longer overcome it if the inlet opening 7 in the storage tank 5 is closed when the storage container has been removed. As soon as additive 3 is taken from the storage tank (without a storage container 1 inserted into the metering device), the level in the ascending tube 20 on the storage tank drops and finally, the storage tank 5 is vented via the venting opening 19 in the ascending tube 20. With the insertion of a new storage tank 1, the integrated storage tank 5 and the ascending tube 20 are again filled with additive, as shown in FIG. 1.

In FIG. 1, the metering device in accordance with the invention is equipped with a completely filled storage container 1, wherein the storage container 1 is connected with the integrated storage tank 5 via the connecting piece 13. By means of this connection, it is possible for the additive found in the storage container 1 to flow into the storage tank 5 through the outlet opening 6 of the storage container 1 and the inlet opening 7 of the storage tank 5 until it is completely filled with a pure (that is, undiluted and not mixed with other (additive) agents) additive 3. With a filled storage tank 5, the additive found in the storage tank 5 can be suctioned via the connecting conduit 16 using the metering pump 2, and can be conducted to the treatment liquid of the vehicle treatment installation via the connecting conduit 17. During the suctioning of the additive found in the storage tank 5, the additive 3 flows subsequently from the replaceable storage container into the storage tank 5. FIG. 2 shows the metering device with an approximately half-evacuated storage container 1 with a still completely filled storage container 5. With additional removal of additive from the storage tank 5, the replaceable storage container 1 is further evacuated until, as shown in FIG. 3, there is still only a small remainder of additive contained in the replaceable storage container 1. As soon as the liquid level in the replaceable storage container 1 has attained or fallen short of the level of the outlet opening 6 or the inlet opening 7, no further inflow of additive takes place into the still completely filled storage tank 5. It is then vented via the venting opening 19 in the ascending tube 20 (FIGS. 3 and 4). Now, if more additive is removed by suctioning from the storage tank 5, the liquid level in the storage tank 5 falls to a prespecified limiting level G, at which point, the filling level meter 9 emits a signal to the control unit 4 (FIG. 4). The control unit 4 then indicates the dropping of the liquid level in the storage tank 5 below the prespecified limiting level with an acoustic or optical signal. In this way, the operator receives the signal that the replaceable storage container 1 is largely or already completely evacuated.

On the basis of the measurement data recorded by the meters (filling level meter 9 and flow meters 9′) and the material and ambient parameters contained in the data processing device of the control unit 4, the control unit 4 then calculates the still expected remaining life of the metering device. It is essentially determined by the available volume of the additive in the storage tank 5 and the metering capacity of the metering pump 2, adjusted by the control unit 4. On the basis of these data, the data processing device of the control unit 4 calculates the expected remaining life of the metering device and indicates it, for example, via a display or via a data conduit to a remote display device. The remote display device can be, for example, a computer screen or a smart phone that is coupled with the control unit 4 via a data conduit or a wireless data connection. On the basis of the remaining life calculated and indicated by the control unit 4, the operator can estimate when the evacuated storage container 1 must be replaced with a new, filled storage container 1 in order to guarantee an uninterrupted operation of the vehicle treatment installation.

Appropriately, the adjustment of the metering capacity (metering quantity per unit time) of the metering pump 2 is first carried out by taking into consideration the material and ambient parameters, such as the water hardness and the pH value of the treatment liquid, the viscosity and the concentration of the additive in the storage container 1, the temperature, the air pressure and the air humidity, and so forth. The thus adjusted theoretical value of the metering capacity can be compared to the actual metering capacity of the metering pump 2 by the data processing device of the control unit 4. The actual metering capacity of the metering pump 2 can be thereby determined, for example, during the operation of the metering device, by the stroke count of the metering pump 2. After a complete evacuation of the storage container 1 (FIG. 3) and the emitting of a corresponding signal by the control unit 4, a recalibration of the theoretical metering capacity of the metering pump 2 appropriately takes place by taking into consideration the determined actual metering capacity and the recorded measurement data. With an adaptation of the theoretical metering capacity, if this appears to be expedient, it is possible to prolong the remaining life of the metering device, for example, in that the theoretical metering capacity is lowered in comparison to the determined actual metering capacity. The adjustment or the selection of an adapted theoretical metering capacity can be directly undertaken by the operator on the control unit 4 or also via a remote control of the control unit 4. For a remote control of the control unit 4, it is connected, as it also is for data transmission, for example, via a data conduit, with a remote computer or via a wireless data connection with a remote smart phone.

The metering device in accordance with the invention makes it possible for the replaceable storage container 1 to be completely evacuated before it is replaced with a new, filled storage container 1, without having to shut down the vehicle treatment installation for the replacement of a storage container. This proves to be very advantageous, in particular with storage containers with highly concentrated additives, because these highly concentrated additives are very expensive and their residues are difficult to dispose of The operator of the vehicle treatment installation receives, namely, via the control unit, a signal when there is an evacuation of the used storage container 1, on the one hand, and at the same time, a value for the expected remaining life of the metering device. Taking into consideration the remaining life determined by the control unit 4, the operator does not have to immediately replace the (largely or already completely) evacuated storage container 1 with a new, filled storage container. Rather, he can first await a part of the expected remaining life and therefore postpone the replacement to a later time. This is particularly advantageous if the used storage container 1 is evacuated at an unfavorable time (for example, on the weekend), when the operator is not on site at the vehicle treatment installation. It proves to be advantageous also to wait with the replacement of an evacuated storage container with a filled storage container if there are several metering devices in accordance with the invention with replaceable storage containers 1 in the vehicle treatment installation. The operator can then wait, taking into consideration the determined remaining time of the metering device for each individual additive, until several of these storage containers with different additives have been evacuated and must be replaced with new, filled storage containers. The replacement of the various storage containers can then take place efficiently in one operation. The metering device in accordance with the invention and the method in accordance with the invention therefore make possible a very efficient replacement of evacuated storage containers with new, filled storage containers.

1. Metering device for the metering of additives into treatment liquids of a vehicle treatment installation, with a replaceable storage container and a metering pump that is connected with the storage container and that meters an additive contained in the storage container into the treatment liquid, wherein the metering device contains an integrated storage tank, which is connected, on the one hand, with the metering pump and, on the other hand, with the storage container.

2. Metering device according to claim 1, wherein the metering pump is connected with the replaceable storage container only via the integrated storage tank.

3. Metering device according to claim 1, wherein the replaceable storage container has an outlet opening that is directly connected with an inlet opening in the storage tank so as to transfer the additive contained in the storage container to the storage tank.

4. Metering device according to claim 3, wherein the inlet opening is located in the upper area of the storage tank.

5. Metering device according to claim 1, wherein a filling level meter or a flow meter is located in the storage tank and/or in the storage container.

6. Metering device according to claim 5, wherein the filling level meter is located in the upper area of the storage tank so as to detect whether the additive is being transferred from the replaceable storage container to the storage tank.

7. Metering device according to claim 1, wherein it comprises a control unit to control the metering pump, wherein the control unit has a data processing device.

8. Metering device according to claim 7, wherein the filling level meter or the flow meter is coupled with the control unit in order to transmit the recorded filling level or the recorded through flow quantity on the data processing device of the control unit.

9. Metering device according to claim 7, wherein the control unit controls the metering pump as a function of parameters that are supplied to the data processing device or are deposited in a data storage unit of the data processing device.

10. Metering device according to claim 9, wherein the parameters contain ambient parameters, in particular the ambient temperature and/or the air pressure and/or the air humidity and/or material parameters, in particular the viscosity of the additive (3) and/or the degree of hardness and/or the pH value of the treatment liquid.

11. Metering device according to claim 7, wherein the control unit can be controlled from a site that is removed from the location of the metering device, via a data conduit or a wireless data connection.

12. Metering device according to claim 1, wherein the replaceable storage container is provided with a data carrier that contains data for the additive contained in the storage container.

13. Metering device according to claim 12, wherein a sending/receiving unit is provided for data transfer between the data carrier and the data processing device of the control unit.

14. Data device according to claim 1, wherein the integrated storage tank has a venting opening.

15. Vehicle treatment installation with a number of metering devices according to claim 1, wherein each metering device has a holder for a replaceable storage container, an integrated storage tank, and a metering pump, and the metering pumps of the individual metering devices are controlled by a central control unit.

16. Method for the metering of additives into treatment liquids of a vehicle treatment installation by means of a metering device with an integrated storage tank and a metering pump that is connected with the storage tank, with the following steps:
preparation of a replaceable storage container that contains the additive and insertion of the storage container into a holder of the metering device provided for the purpose;
setting up a connection between the replaceable storage container and the storage tank integrated in the metering device, and transfer of the additive from the storage container to the storage tank until the tank is completely filled;
suctioning of the additive contained in the storage tank and metering of the suctioned additive into the treatment liquid by means of the metering pump.

17. Method according to claim 16, further including the steps of:
recording of the filling level of the additive in the storage tank and/or the flow of additive from the replaceable storage container to the storage tank;
emitting of a signal to a control device as soon as the recorded filling level or the flow quantity falls short of a prespecified limiting value.

18. Method according to claim 16, further including the step of:
calculation of the still expected remaining life of the metering device, taking into consideration the recorded filling level or the recorded flow quantity and/or the previous metering capacity of the metering device and/or ambient parameters and/or material parameters.

19. Method according to claim 18, wherein the previous actual metering capacity of the metering device is recorded and is taken into consideration in the calculation of the remaining life so as to calculate and adjust a theoretical metering capacity.

20. Metering device according to claim 1, wherein the additive contained in the replaceable storage container is present in a highly concentrated form as a liquid or gel.
